(19) United States
(12) Patent Application Publication
(10) Pub. No.: US 2007/0043150 A1
(43) Pub. Date: Feb. 22, 2007

(54) Flame retardant interior sheet with low smoke emission

(76) Inventors: Min-Ho Lee, Gyeongsangnam-do (KR); Kang-Youp Lee, Chungcheongbuk-do (KR); Hyung-Min Cha, Chungcheongbuk-do (KR); Young-Ho Cho, Pusan (KR)

Correspondence Address: CANTOR COLBURN, LLP, 55 GRIFFIN ROAD SOUTH, BLOOMFIELD, CT, 06002, US

(21) Appl. No.: 10/557,216

(22) PCT Filed: May 14, 2004
(86) PCT No.: PCT/KR04/01142

§ 371 Date: Nov. 15, 2005

(30) Foreign Application Priority Data
May 16, 2003 (KR) 10-2003-0031126

(51) Int. Cl. C08K 5/52; C08F 214/06

(52) U.S. Cl. 524/141; 524/437; 524/436; 524/567

(57) ABSTRACT

Disclosed herein is a low smoke and flame retardant composition for a decorative sheet which generates less combustion gases and has excellent flame retardancy. The low smoke and flame retardant composition comprises 100 parts by weight of a PVC resin as a base resin, 5˜30 parts by weight of a phosphorus (phosphate)-based plasticizer (e.g., isodecyl diphenyl phosphate), a flame retardant and a smoke suppressant. A mixture of 2˜20 parts by weight of aluminum hydroxide and 2˜20 parts by weight of magnesium hydroxide is used as the flame retardant, and 0.5˜10 parts by weight of a molybdenum compound having an average particle size of 2˜5 microns is used as the smoke suppressant.

### TECHNICAL FIELD

The present invention relates to a low smoke and flame retardant composition for a decorative sheet which generates less combustion gases and has excellent flame retardancy, and a decorative sheet comprising at least one layer containing the composition.

### BACKGROUND ART

A large amount of smoke including toxic gases generated during a fire results in great loss of life. To ensure safety against fire, there exists a strong need for decorative sheets with excellent flame retardancy by using flame retardant plasticizers, flame retardants and smoke suppressants.

In this connection, much research has been conducted on the flame retardancy and fire resistance of decorative sheets. In addition, a number of studies to decrease the amount of smoke generated upon combustion are being actively undertaken.

Several low smoke and flame retardant resin compositions for decorative sheets are disclosed in Japanese Patent Laid-open Nos. 1997-048083, 1998-287781, 2000-086810 and 2000-129263, and U.S. Pat. Nos. 4,544,695, 6,316,118 and 6,355,277.

According to these patent publications, large amounts of hydroxides or phosphorus-based flame retardant as auxiliary flame retardants are used to improve the flame retardancy of the sheets. The addition of hydroxides delays the time of smoke generation and slows the rate of smoke generation because of the endothermic reaction of water elimination during thermal decomposition. In addition, a smoke suppressant, such as zinc borate, is used as an auxiliary to improve low smoke generation properties.

### DISCLOSURE OF INVENTION

### Technical Problem

However, if hydroxides are added in large amounts in order to obtain low smoke generation properties, they cause poor mechanical properties and processability in the manufacture of decorative sheets.

With the aim of solving these drawbacks, a metal hydride whose surface is treated with a silicon coupling agent or processing aid, is often used. However, there is a problem that large amounts of incomplete combustion gases upon combustion are generated.

As a result of testing prior art flame retardant materials by the flaming procedure described in the ASTM E 662 and ISO 5659 standard test methods, the smoke density did not come up to the standard value and the combustion was continued, resulting in an increase in the amount of smoke generation. Thus, the prior arts have many technical limitations and problems in decreasing the amount of smoke generation in decorative sheets.

In order to solve the aforementioned problems, flame retardants must have the following characteristics: high compatibility with soft polyvinyl chloride (PVC) resins, flame retardant effects without causing deterioration in physical properties, constant stability against light without causing discoloration of raw materials, excellent resistance to aging and hydrolysis, continued flame retardant effects in the range of from a temperature lower than thermal decomposition temperature of base polymers to the thermal decomposition temperature, no corrosion, good heat resistance, no odor and toxicity, and less generation of smoke and toxic gases upon combustion.

### Technical Solution

Therefore, the present invention has been made in view of the above problems associated with smoke generation of decorative sheets, and it is an object of the present invention to provide a soft PVC sheet composition which is excellent in processability and mechanical properties, e.g., tensile strength and elongation.

### Advantageous Effects

It is another object of the present invention to provide a decorative sheet having improved low smoke generation properties, particularly, a low smoke density as measured in accordance with the ISO 5659 standard test method. The present inventors have earnestly and intensively conducted research to improve low smoke generation properties. As a result, the present inventors have found that when a phthalate-based plasticizer negatively affecting smoke density is replaced with a phosphate-based plasticizer, a low smoke and flame retardant composition having excellent low smoke generation properties, processability and mechanical properties can be prepared. The present inventors have also found that when a combination of a hydroxide (e.g., magnesium or aluminum hydroxide) and a molybdenum-based compound is used as a smoke suppressant instead of the hydroxide alone, a low smoke and flame retardant composition can be prepared. The present invention has been accomplished on the basis of these findings.

### Best Mode

In order to accomplish the above objects of the present invention, there is provided a low smoke and flame retardant composition comprising 100 parts by weight of a PVC resin as a base resin, 5˜30 parts by weight of a phosphorus (phosphate)-based plasticizer (e.g., isodecyl diphenyl phosphate), a flame retardant and a smoke suppressant.

As the flame retardant, a mixture of 2˜20 parts by weight of aluminum hydroxide and 2˜20 parts by weight of magnesium hydroxide is used. As the smoke suppressant, 0.5˜10 parts by weight of a molybdenum compound having an average particle size of 2˜5 microns is used.

DOP (di-2-ethylhexylphthalate) as a conventional plasticizer used to prepare a soft PVC sheet composition generates large amounts of gasses. In the present invention, a phosphorus-based flame retardant plasticizer is used instead of DOP. The phosphorus-based plasticizer has the same physical properties as DOP, improved low smoke generation properties and excellent flame retardant effects. A preferred phosphorus-based flame retardant plasticizer is isodecyl diphenyl phosphate. The phosphorus-based flame retardant plasticizer is present in an amount of 5-30 parts by weight, based on 100 parts by weight of the PVC resin. Within the content range, since the composition of the present invention has improved low smoke generation properties and a plasticization rate substantially similar to DOP, it can exhibit superior processability and excellent mechanical properties.

Non-halogen phosphates are divided into four types depending on their chemical structure. Triaryl phosphates, such as Reophos^{?}, TPP (triphenyl phosphate) and TCP (tricresyl phosphate), are widely used as general-purpose flame retardants. Trialkyl phosphates are mainly used as plasticizers or lubricants. Alkylaryl phosphates have an aryl group and a long-chain alkyl group in their molecular structure. Examples of alkylaryl phosphates include ODP (2-ethylhexyl phosphate), IDDPP (isodecyl diphenyl phosphate) and the like.

The presence of the alkyl and aryl groups in a single molecular structure is important in terms of low smoke generation. When the organic plasticizer is combined with an inorganic flame retardant, the low smoke generation properties are further improved.

For the purpose of delaying the initial combustion time of the base resin and the rate of smoke generation and further improving the mechanical properties and processability of the composition according to the present invention, a metal hydroxide (e.g., a magnesium or aluminum hydroxide) whose surface is treated with stearic acid is used in an amount of 4˜40 parts by weight, based on 100 parts by weight of the PVC resin.

When the amount of the metal hydroxide is less than 4 parts by weight, sufficient flame retardant effects and delaying effects on the rate of smoke generation cannot be achieved. Meanwhile, when the amount of the metal hydroxide exceeds 40 parts by weight, the mechanical properties of the composition are deteriorated.

On the other hand, since the use of the metal hydroxide alone cannot satisfy the criteria of flame retardant performance defined in the Korean Fire Law KOFEIS 1001), Sb₂O₃ (antimony trioxide) effective in improving self-extinguishing properties and blocking fire propagation is essentially added. In the present invention, Sb₂O₃ is added in an amount of 2˜6 parts by weight, based on 100 parts by weight of the PVC resin.

However, since the amount of smoke to be generated increases in proportion to the content of Sb₂O₃, Sb₂O₃ is preferably added in such a limited amount that the fire propagation is effectively blocked.

When Sb₂O₃ is used in an amount of less than 2 parts by weight, blocking effects on fire propagation are unsatisfactory. On the other hand, when Sb₂O₃ is used in an amount exceeding 6 parts by weight, the smoke generation is increased.

Since the self-extinguishing properties of the metal hydroxide have a limitation in decreasing the amount of smoke generation, 0.5˜10 parts by weight of the molybdenum compound, based on 100 parts of the PVC resin, having an average particle size of 2˜5 microns as a smoke suppressant is combined with the metal hydroxide, as described above. When the amount of the molybdenum compound added is less than 0.5 parts by weight, low smoke generation properties are not attainable. On the other hand, when the amount of the molybdenum compound is more than 10 parts by weight, the physical properties of the composition are deteriorated.

For the purpose of improving heat resistance and preventing discoloration caused by heat during processing, the composition of the present invention further comprises 2˜5 parts by weight of a barium zinc-based thermal stabilizer, based on 100 parts by weight of the PVC resin. The addition of the thermal stabilizer can improve poor heat resistance of the phosphorus-based flame retardant plasticizer (e.g., IDDPP).

The low smoke and flame retardant composition of the present invention can be applied to a decorative sheet having a general laminate structure.

Therefore, in accordance with another aspect of the present invention, there is provided a low smoke and flame retardant decorative sheet comprising a transparent film, a printed layer, a colored film and a pressure-sensitive adhesive layer laminated in this order from the top wherein at least one layer selected from these layers contains the low smoke and flame retardant composition. Preferably, the colored film contains the low smoke and flame retardant composition.

The present invention will now be described in more detail with reference to the following examples. However, these examples are not to be construed as limiting the scope of the invention.

### EXAMPLES

Low smoke and flame retardant compositions of the present invention (Examples 1˜3) and compositions of Comparative Examples 1 and 2 were prepared so as to have the compositions indicated in Table 1 below, and the smoke density and flame retardancy of the compositions were evaluated. The results are summarized in Table 2 below.

<Manufacture of Low Smoke and Flame Retardant Decorative Sheets and Smoke Generation Test>

Each of low smoke and flame retardant compositions of Examples 1˜3 and Comparative Examples 1 and 2 was mixed in a roll mill at 185° C. for 10 minutes to obtain test pieces. The smoke density and flame retardancy of the compositions were evaluated using the test pieces as follows.

1) Smoke density was measured by the ASTM E662 and ISO5659 standard test methods (Heat Flux: 2.5 W/cm²).

Detailed test conditions were set in accordance with the flaming procedure, and

0.1 mm thick, 75 mm wide and 75 mm long test pieces were used.

2) Heat resistance: Test pieces were taken out from the roll mill at 185° C. at intervals of 10 minutes over 60 minutes, and then their discoloration was determined.

TABLE 1

| | | Content | | | | |
|---|---|---|---|---|---|---|
| | | Examples | | | Comparative Examples | |
| Components | | 1 | 2 | 3 | 1 | 2 |
| PVC resin | | 100 | 100 | 100 | 100 | 100 |
| Plasticizers | DOP | — | — | — | 16 | 16 |
| | IDDPP | 16 | 16 | 16 | — | — |
| Flame | Al(OH)₃ | 15 | 7.5 | 7.5 | 15 | 7.5 |
| retardants | Mg(OH)₂ | — | 7.5 | 7.5 | — | 7.5 |
| | Sb₂O₃ | 3 | 3 | 1.5 | 3 | 3 |
| Smoke | Molybdenum | — | — | 1.5 | — | — |
| suppressant | | | | | | |

* IDDPP: Isodecyldiphenylphosphate

TABLE 2

| | | Results | | | | |
|---|---|---|---|---|---|---|
| | | Examples | | | Comparative Examples | |
| Properties | | 1 | 2 | 3 | 1 | 2 |
| Smoke generation | ASTM E 662 | 70 | 65 | 35 | 85 | 80 |
| properties | ISO 5659 | 40 | 35 | 30 | 60 | 55 |

| | | | | | |
|---|---|---|---|---|---|
| Flame retardancy (KOFEIS1001) | Δ | Δ | ◯ | Δ | ◯ |

The compositions of Comparative Examples 1 and 2 had excellent flame retardancy and heat resistance during processing, but they had a relatively high smoke density. The smoke density of the compositions of Comparative Examples 1 and 2 exceeded the standard range of flame retardant performance defined in the Korean Fire Law KOFEIS 1001) that will be revised in the near future.

In the case of a 0.1 mm thick test piece, a preferred standard range is 60 or less in the ASTM E 662 standard test method, and 50 or less in the ISO 5659 standard test method.

In particular, since the low smoke and flame retardant composition of Example 3 comprises IDDPP as a phosphorus-based plasticizer, and a molybdenum compound and a metal hydroxide as auxiliary smoke suppressants, it exhibited excellent low smoke generation properties and at the same time improved flame retardancy.

### INDUSTRIAL APPLICABILITY

As apparent from the foregoing, since the low smoke and flame retardant composition for a decorative sheet according to the present invention comprises a phosphorus-based plasticizer instead of DOP as a conventional plasticizer and a combination of molybdenum compound and a metal hydroxide, it exhibits markedly decreased smoke density upon combustion. In addition, the low smoke and flame retardant composition for a decorative sheet according to the present invention has heat resistance equal to or greater than conventional compositions, and thus has excellent processability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A low smoke and flame retardant composition for a decorative sheet, comprising:
parts by weight of a PVC resin;
5-30 parts by weight of a phosphorus-based plasticizer;
a flame retardant; and
a smoke suppressant.

2. The composition according to claim 1, wherein the phosphorus-based plasticizer is isodecyl diphenyl phosphate.

3. The composition according to claim 1, wherein the composition comprises:
100 parts by weight of a PVC resin;
5-30 parts by weight of isodecyl diphenyl phosphate;
4-40 parts by weight of a mixture of aluminum hydroxide and magnesium hydroxide;
2-6 parts by weight of Sb₂O₃; and
0.5-10 parts by weight of a molybdenum compound having an average particle size of 2-5 microns.

4. The composition according to claim 3, further comprising 2-5 parts by weight of a barium zinc-based thermal stabilizer, based on 100 parts by weight of the PVC resin.

5. A low smoke and flame retardant decorative sheet comprising at least one layer containing a composition according to claim 1.

6. The decorative sheet according to claim 5, wherein the decorative sheet comprises a transparent film, a printed layer, a colored film and a pressure-sensitive adhesive layer laminated in this order from the top.

7. The decorative sheet according to claim 6, wherein the colored film contains a composition comprising 100 parts by weight of a PVC resin; 5-30 parts by weight of a phosphorus-based plasticizer; a flame retardant; and a smoke suppressant.

8. A low smoke and flame retardant decorative sheet comprising at least one layer containing a composition according to claim 3.

9. The decorative sheet according to claim 8, wherein the decorative sheet comprises a transparent film, a printed layer, a colored film and a pressure-sensitive adhesive layer laminated in this order from the top.

10. The decorative sheet according to claim 9, wherein the colored film contains a composition according comprising 100 parts by weight of a PVC resin; 5-30 parts by weight of isodecyl diphenyl phosphate; 4-40 parts by weight of a mixture of aluminum hydroxide and magnesium hydroxide; 2-6 parts by weight of Sb₂O₃; and 0.5-10 parts by weight of a molybdenum compound having an average particle size of 2-5 microns.
